(19) United States
(12) Patent Application Publication
(10) Pub. No.: US 2019/0289197 A1
(43) Pub. Date: Sep. 19, 2019

(54) IMAGE CAPTURE DEVICE AND METHOD FOR SECURE IMAGE STORAGE

(71) Applicant: Re Mago Holding LTD, London (GB)

(72) Inventor: Marco Valerio Masi, Lugano Paradiso (CH)

(21) Appl. No.: 16/290,362

(22) Filed: Mar. 1, 2019

Related U.S. Application Data
(60) Provisional application No. 62/643,520, filed on Mar. 15, 2018.

(51) Int. Cl. H04N 5/232; H04N 5/3745; G06F 3/0488

(52) U.S. Cl. CPC H04N 5/23216; H04N 5/23245; G06F 3/04883; H04N 5/37452

(57) ABSTRACT

An apparatus and method for secure image storage including storing, in a memory of an image capture device, a first region accessible only to an authenticated user and a second region accessible to a non-authenticated user, storing, in the memory of the image capture device, a variable having a first state and a second state, capturing, by a camera of the image capture device, an image, and storing, by the controller of the image capture device, the captured image in the memory, the controller being configured to store the captured image in the first region when the variable is in the first state during image capture and store the captured image in the second region when the variable is in the second state during image capture.

### RELATED APPLICATION DATA

This application claims priority to U.S. Provisional Application No. 62/643,520, filed Mar. 15, 2018, the disclosure of which is hereby incorporated by reference in its entirety.

### BACKGROUND

Digital photography has long overtaken film as the medium used to capture, document, and store images. In particular, the integration of digital cameras into most smartphones has resulted in a steep rise in the quantity of photographs captured by the users of these smartphones.

Privacy is one of the primary concerns of many users, particularly with respect to personal or sensitive images. Photographs stored on smartphones and digital cameras are not inherently secure or protected from tampering or hacking, either directly or through a network connection. Additionally, cloud storage of photographs, such as on social media sites, brings its own set of challenges and privacy concerns. Many social media sites share confidential images and photographs of users with third parties, and others are susceptible to hacking or data theft.

Additionally, the process for securing captured images can frequently be cumbersome and deter many users from adequately protecting captured images. Typically, the user must install or set up some hardware or software that allows the user to set up access controls on particular folders stored on the hardware or in memory. The user must then manually transfer each image file they would like to protect to the appropriate location in the hardware or memory.

Furthermore, even the process described above still has glaring security weaknesses. In particular, the time period between when an image is captured and when the image is transferred to a secured folder provides a window of opportunity to hackers or bad actors to access the image after capture but prior to transfer to the secured folder. Within this window, no security features or access controls limit access to the captured images (outside of basic security features that may be part of the general operating environment).

Accordingly, improvements are needed in systems and methods for secure image storage.

### DESCRIPTION

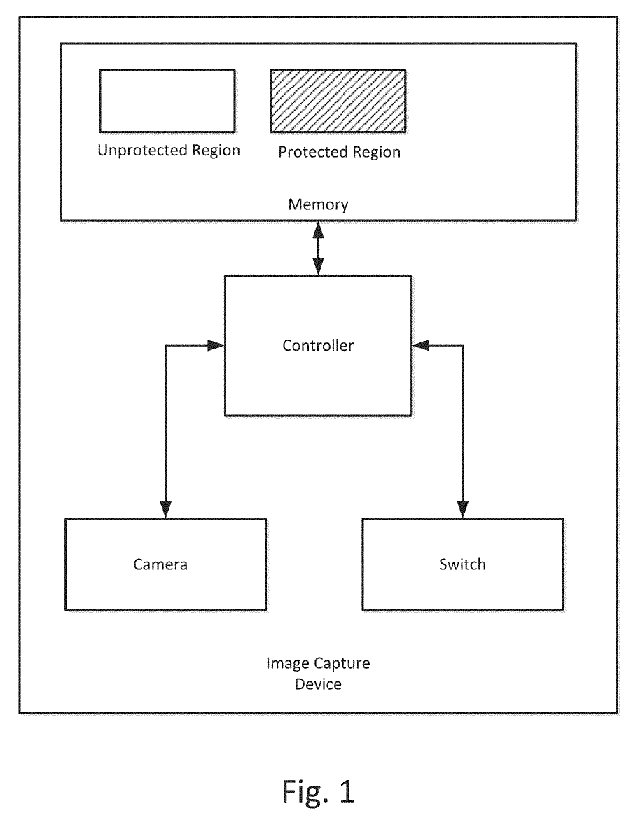

FIG. 1 illustrates an image capture device according to an exemplary embodiment.

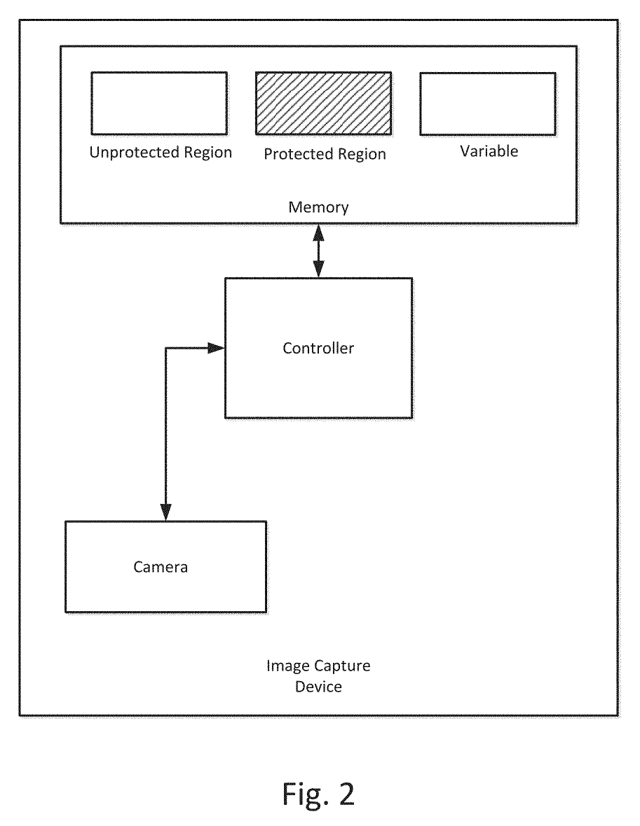

FIG. 2 illustrates a second image capture device according to an exemplary embodiment.

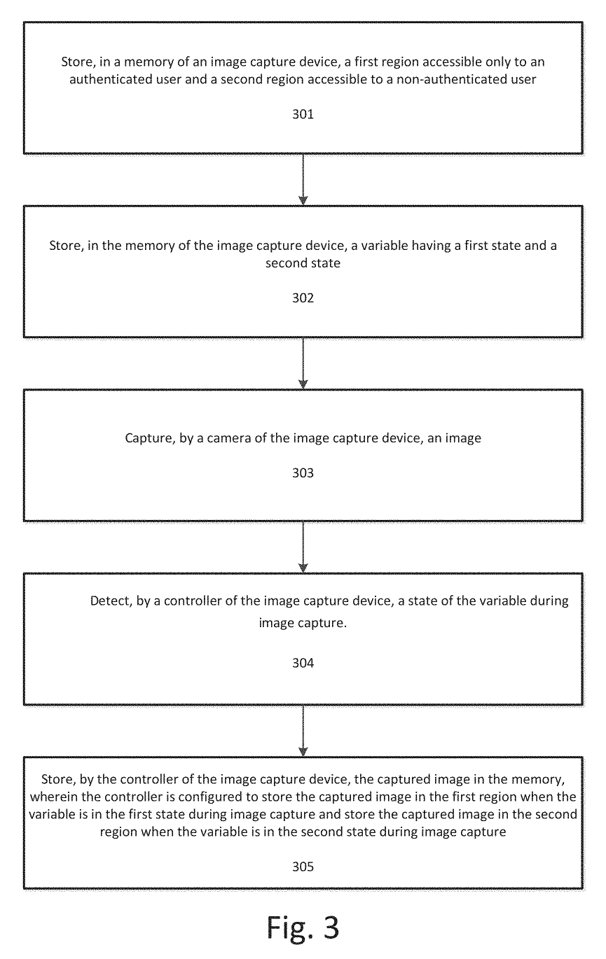

FIG. 3 illustrates a method for secure image storage according to an exemplary embodiment.

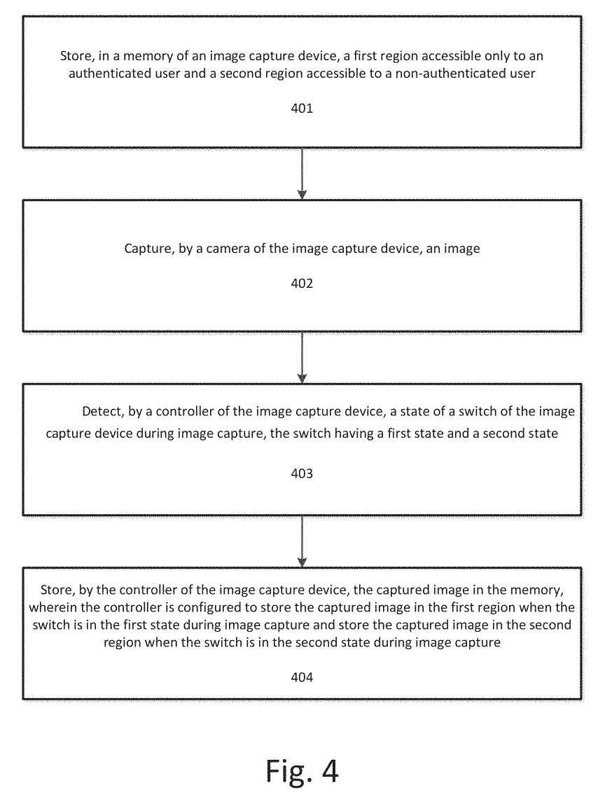

FIG. 4 illustrates a method for secure image storage according to an exemplary embodiment.

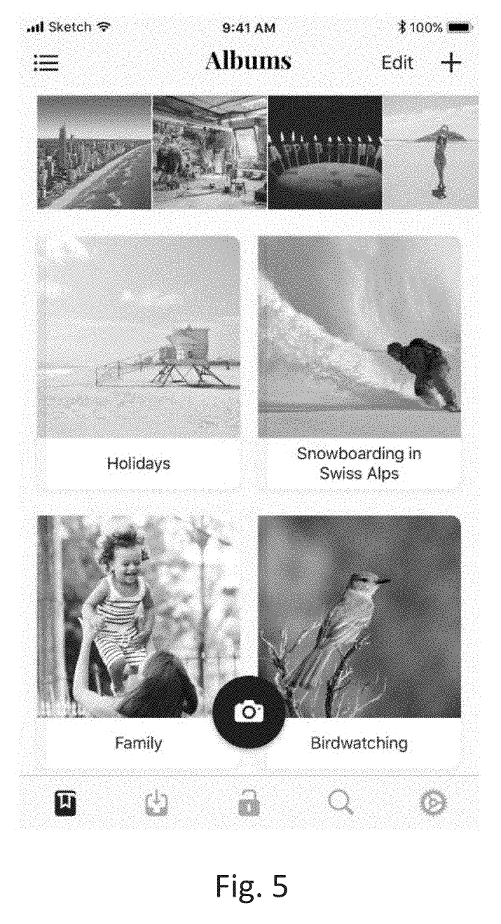

FIGS. 5-9 illustrate various user interfaces of an image capture device according to an exemplary embodiment

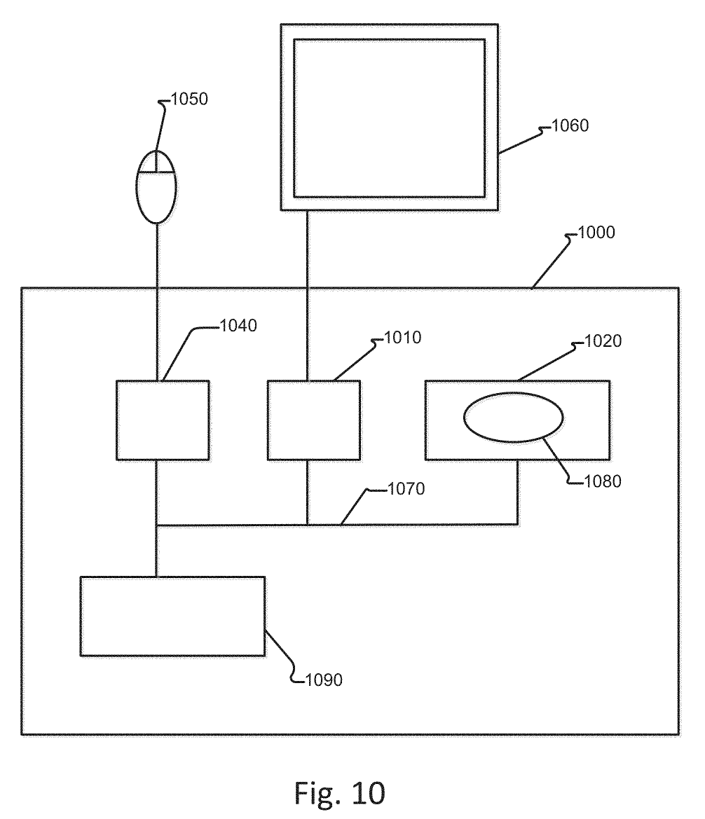

FIG. 10 illustrates a computing environment used to perform the method for secure image storage according to an exemplary embodiment.

### DETAILED DESCRIPTION

While devices, adapters, methods, apparatuses, and computer-readable media are described herein by way of examples and embodiments, those skilled in the art recognize that devices, adapters, methods, apparatuses, and computer-readable media for image capture devices and secure image storage are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

FIG. 1 illustrates an image capture device according to an exemplary embodiment. As shown in FIG. 1, the image capture device includes a memory, the memory comprising a first protected region accessible only to an authenticated user and a second non-protected region accessible to a non-authenticated user. The protected region is a secure region of memory that requires authentication to access. In addition to authentication, the protected region can be protected in a variety of ways, such as encryption or data masking. The protections associated with the secure region can be encoded in memory, such as through hardware, or in the software which is used to access the secure region, or in a memory controller.

As shown in FIG. 1, the image capture device also includes a camera, such as a digital camera, configured to capture an image. The camera can be configured to capture multiple images or video, which is a sequence of images. The image capture device also includes a switch having a first state and a second state. Switch can optionally have more than two states, such as three or four states. When more than two states are used, each state can correspond to a level of protection. For example (state 1 =no protection, state 2 =authentication, state 3=authentication+encryption, state 4=authentication+encryption+masking). In this example, four different regions of memory would be designated accordingly and the captured image would be stored in one of the four regions by the controller depending on the state during image capture.

The image capture device also includes a controller configured to store the captured image (or captured video) in the memory. The controller is configured to store the captured image in the protected region when the switch is in the first state during image capture and store the captured image in the unprotected region when the switch is in the second state during image capture. The controller can additionally be configured to detect the state of the switch during image capture. For example, at the time of photo (or video) capture the controller detect the state or position of the switch and store a value in the memory (or in a controller sub-memory) that corresponds to the state of the switch at the capture time. This value can then be used when determining a storage destination for the captured image.

The controller can be a hardware controller or a software controller, such as an application, program, script, or process running on the image capture device. For example, the controller can be a hardware controller of the camera or other hardware components or of the entire image capture device. Controller can also be a process or script such as an operating system process or an application running on the image capture device.

The switch can be a mechanical switch that is configured to be toggled between the first state and the second state by a mechanical force. For example, the switch can be a lever or similar structure. The switch can be toggled by a user of the image capture device. The switch can also be a depressible button configured to toggle the switch between the first state and the second state. For example, if the switch is a button, then the user can push both the shutter button (a button coupled to the shutter) and the switch button at the same time to toggle protected mode and store captured images in the protected region. Otherwise, if the user pushes only the shutter button, then captured images can be stored in the unprotected region. The switch can also be a variety of other mechanical structures, such as knob, depressible button that is configured to lock in two different positions, a rotating gear, or any other mechanical structure.

FIG. 2 illustrates a second image capture device according to an exemplary embodiment. As shown in FIG. 2, the second image capture device includes a memory, the memory comprising a first protected region accessible only to an authenticated user and a second non-protected region accessible to a non-authenticated user. The protected region is a secure region of memory that requires authentication to access. In addition to authentication, the protected region can be protected in a variety of ways, such as encryption or data masking. The protections associated with the secure region can be encoded in memory, such as through hardware, or in the software which is used to access the secure region, or in a memory controller.

As shown in FIG. 2, the second image capture device also includes a camera, such as a digital camera or a camera integrated into a mobile device, such as a smartphone, configured to capture an image. The camera is configured to capture multiple images or video, which is a sequence of images.

The second image capture device also includes a variable having a first state and a second state. Variable can optionally have more than two states, such as three or four states or infinite states. Variable can be, for example, a Boolean variable, an integer (able to be set to at least “0” and “1”), a character, a string, or any other type of object. For example, the variable can be a Boolean variable called “SecureMode” and having two states (true and false). The variable can be an integer variable called “SecureMode” and having at least two states (0 and 1, in addition infinite other states). When more than two states are used, each state can correspond to a level of protection. For example (state 1=no protection, state 2=authentication, state 3=authentication+encryption, state 4=authentication+encryption+masking). In this example, four different regions of memory would be designated accordingly and the captured image would be stored in one of the four regions by the controller depending on the state during image capture.

As shown in FIG. 2, variable is also stored in memory. Optionally, variable can be stored in a different memory than the protected region and unprotected region. For example, the protected region and the unprotected region can be stored in long term storage, such as a hard drive, and variable can be stored in a cache or in random access memory (RAM).

The second image capture device also includes a controller configured to store the captured image (or captured video) in the memory. The second controller is configured to store the captured image in the protected region when the variable is in the first state during image capture and store the captured image in the unprotected region when the variable is in the second state during image capture. The controller can additionally be configured to detect the state of the variable during image capture. For example, at the time of photo (or video) capture the controller detect the state of the variable and store a value in the memory (or in a controller sub-memory) that corresponds to the state of the variable at the capture time. This value can then be used when determining a storage destination for the captured image (or video).

The controller can be a hardware controller or a software controller, such as an application, program, script, or process running on the image capture device. For example, the controller can be a hardware controller of the camera or other hardware components or of the entire image capture device. Controller can also be a process or script such as an operating system process or an application running on the image capture device.

The second image capture device can additionally include a display comprising a user interface. The user interface can be the interface of an operating system on the second image capture device or the interface of an application running on the second image capture device, such as a camera application or other mobile application. The user interface can be configured to receive an input to toggle the variable between the first state and the second state. The input can be one or more of a touch input, a swipe gesture, or a selection. A touch input can include a timed or pressure sensitive touch.

For example, the user can depress a shutter icon or other icon on a user interface for an extended period of time to (e.g., more than half a second, more than 1 second, more than 2 seconds, etc.) to set the value of the variable to a value that corresponds to a protected state. When the user releases the shutter, the captured image would then be stored in the protected region. A quick press of the shutter icon can, by contrast, not change the value of the variable to a value that corresponds to a protected state, resulting in the captured image being stored in unprotected region. In this example, the variable can by default be reset to a value that corresponds to an unprotected state after every photo or video capture. In another example, the user can depress a camera icon on the user interface that is configured to open the camera (or a specific camera application) for an extended period of time to (e.g., more than half a second, more than 1 second, more than 2 seconds, etc.) to set the value of the variable to a value that corresponds to a protected state when the camera is opened. The variable can then stay in that state for the duration of the camera session or until the user toggles it back.

In another example, the user can swipe on the user interface or on a portion of the user interface to change the variable value and toggle between secure and unsecure modes. The change in modes can be reflected on the user interface using one or more visual cues, such as icons, notifications, color changes, sounds, or visual effects. The change in modes can also communicated to the user using audio. For example, the image capture device can make a first sound for protected mode and a different sound for unprotected mode. The image capture device can also make a sound every time the mode is changed (such as a “ding” sound).

The controllers shown in FIGS. 1 and 2 can be configured to generate and transmit commands to components of the image capture devices shown in FIGS. 1 and 2 or to software executing on those image capture devices in response to detecting a change in the state of the switch (as shown in FIG. 1) or the variable (as shown in FIG. 2). For example, if the switch or variable changes from a state corresponding to an unsecure or “casual” mode to a state corresponding to a secure or “private,” mode, the controller can generate and issue commands to one or more applications running on the image capture devices to mute or modify sound output. For example, the controller can send a command to a camera application that causes the camera application to modify the sound settings associated with the “shutter” to silence the shutter. This allows a user to take pictures in a secure or private mode without the resulting shutter sound being output. Additionally, the controller can send a command to the operating system that causes the operating system to adjust sound settings to silence all system sounds when the switch or variable corresponds to a secure or “private state.”

The controller can also directly communicate with hardware on the image capture device in response to detecting a change in state of a switch (as shown in FIG. 1) or variable (as shown in FIG. 2). For example, the controller can communicate directly with the speaker hardware, motherboard, sound hardware chip, or sound card to adjust output settings and put the image capture into a silent or quiet mode.

FIG. 3 illustrates a method for secure image storage according to an exemplary embodiment. This method can be carried out, for example, using the second image capture device shown in FIG. 2.

At step 301 a first region accessible only to an authenticated user and a second region accessible to a non-authenticated user is stored in a memory of an image capture device. Storing can include designating the first region and the second region and/or provisioning the two regions. For example, the controller can designate the first region as a protected region and the second region as a non-protected region. Storing can also include storing a table, mapping, or other data structure with a correspondence between regions of memory and authenticated access or non-authenticated access. For example, one or more first chunks of memory can be mapped to protected storage (authenticated access) and one or more second chunks of memory can be mapped to non-protected storage (non-authenticated access).

At step 302 a variable having a first state and a second state is stored in the memory of the image capture device. As discussed earlier, this variable can be stored in the same, or a different, memory than the protected and unprotected regions.

At step 303 an image is captured by a camera of the image capture device. This can be in response to a user input, such as a shutter press or input on a user interface.

At step 304 a state of the variable during image capture is detected by controller and can be stored for subsequent use when determining a destination of the captured image.

At step 305 the controller stores the captured image in the memory. As discussed earlier, the controller is configured to store the captured image in the first region when the variable is in the first state during image capture and store the captured image in the second region when the variable is in the second state during image capture.

The method shown in FIG. 3 can additionally include receiving an input in a user interface on a display of the image capture device to toggle the variable between the first state and the second state. This is described with respect to FIG. 2. As discussed earlier, the input can be a variety of different inputs, such as a touch input, a swipe gesture, a selection, or a combination of input.

FIG. 4 illustrates a method for secure image storage according to an exemplary embodiment. This method can be carried out, for example, using the second image capture device shown in FIG. 1.

At step 401 a first region accessible only to an authenticated user and a second region accessible to a non-authenticated user is stored in a memory of an image capture device. Storing can include designating the first region and the second region and/or provisioning the two regions. For example, the controller can designate the first region as a protected region and the second region as a non-protected region. Storing can also include storing a table, mapping, or other data structure with a correspondence between regions of memory and authenticated access or non-authenticated access. For example, one or more first chunks of memory can be mapped to protected storage (authenticated access) and one or more second chunks of memory can be mapped to non-protected storage (non-authenticated access).

At step 402 an image is captured by a camera of the image capture device. This can be in response to a user input, such as a shutter press or input on a user interface.

At step 403 a state of a switch during image capture is detected by controller and can be stored for subsequent use when determining a destination of the captured image. As discussed with respect to FIG. 1, the switch can take a variety of forms and has at least a first state and a second state.

At step 404 the controller stores the captured image in the memory. As discussed earlier, the controller is configured to store the captured image in the first region when the variable is in the first state during image capture and store the captured image in the second region when the variable is in the second state during image capture.

The method shown in FIG. 4 can additionally include toggling the switch between the first state and the second state with a mechanical force or toggling the switch between the first state and the second state with a depressible button, as discussed with respect to FIG. 1.

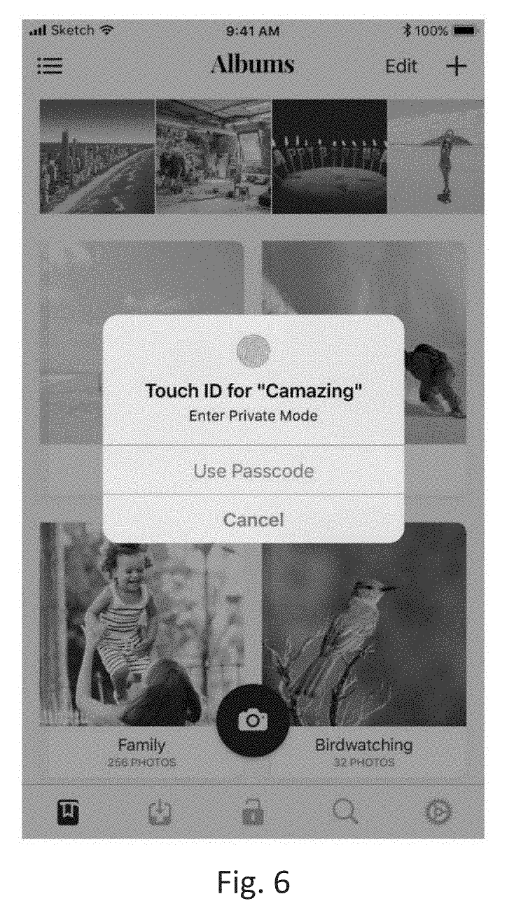

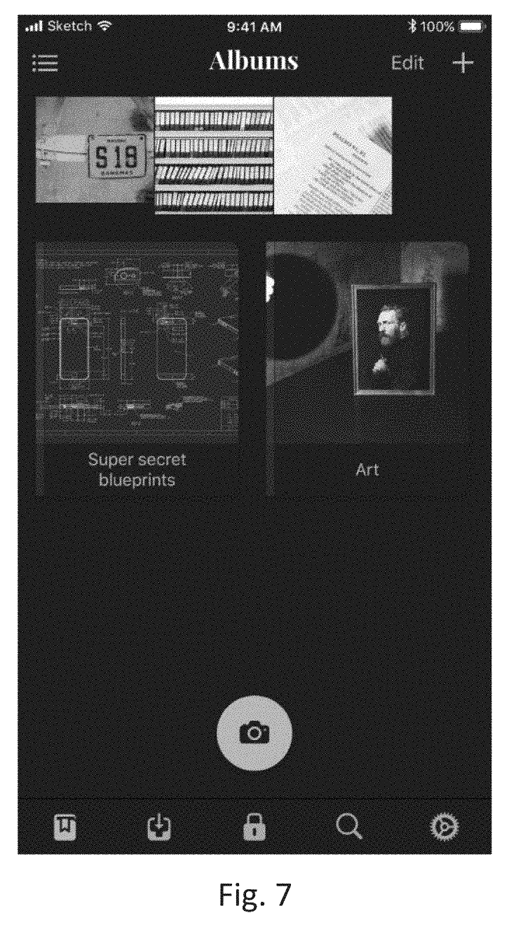

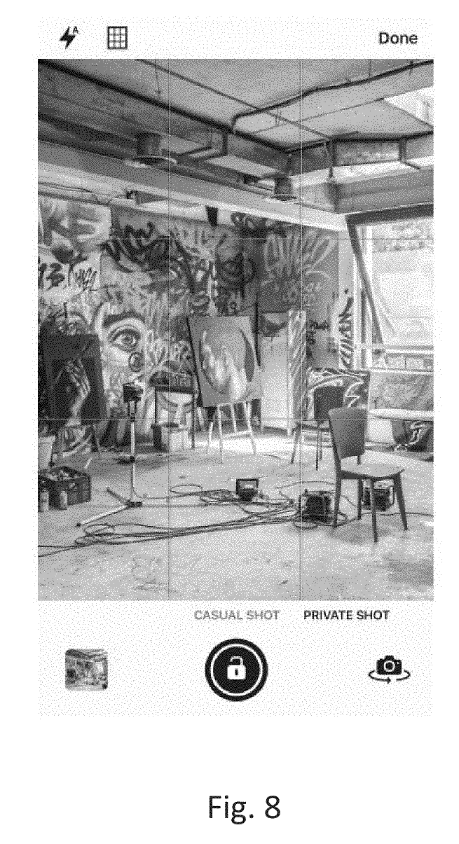

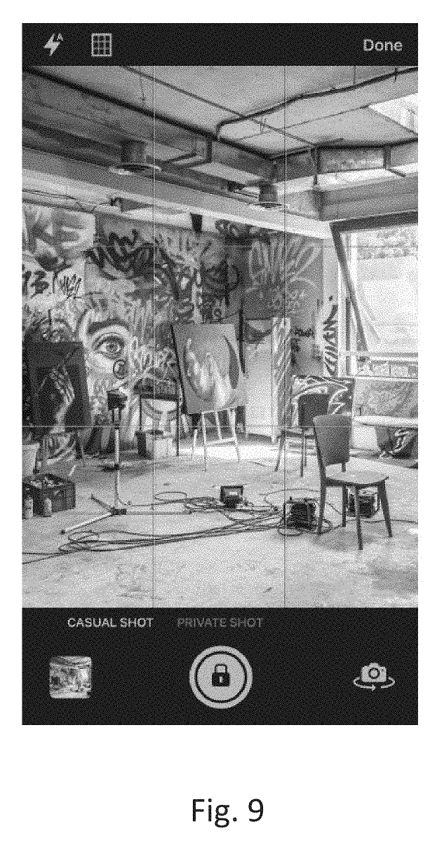

FIGS. 5-9 illustrate various user interfaces of the image capture device according to an exemplary embodiment, including an interface for browsing unprotected images (FIG. 5), an interface for authenticating to access protected images (FIG. 6), an interface for browsing protected images after authentication (FIG. 7—showing a visual change to the UI between protected and unprotected browsing), a user interface for image capture when in unprotected mode (FIG. 8), and a user interface for image capture when in protected mode (FIG. 9—showing a visual change to the UI between protected and unprotected image capture interfaces). The user can transition from the interface shown in FIG. 8 to the one shown in FIG. 9 by, for example, swiping across the bottom of the interface to deselect “casual shot” and select “private shot.” All of the functionality and interfaces described herein can also be applied to videos.

In addition to all of the above disclosures and embodiments, when data corresponding to captured images or videos is stored in the protected region of memory, it can be stored with specific metadata attributes that further identify the images or videos as private and further identify the type of private photo (this can be set based upon user preferences). When data corresponding to captured images or videos is stored in the unprotected region of memory, it can be stored with standard metadata attributes.

As shown above, the image capture device(s) and method(s) disclosed herein allow a user to designate a private and protected image prior to capturing the image by toggling a switch or changing the value of a variable through a user interface.

One or more of the above-described techniques can be implemented in or involve one or more specialized computer systems. FIG. 10 illustrates an example of a computing environment 900.

With reference to FIG. 10, the computing environment 1000 can be a mobile device and includes at least one processing unit 1010 and memory 1020. The processing unit 1010 executes computer-executable instructions and may be a real or a virtual processor. In a multi-processing system, multiple processing units execute computer-executable instructions to increase processing power. The processing unit is part of the specialized controller discussed with reference to FIGS. 1-2.

The memory 1020 may be volatile memory (e.g., registers, cache, RAM), non-volatile memory (e.g., ROM, EEPROM, flash memory, etc.), or some combination of the two. The memory 1020 may store software instructions 1080 for implementing the described techniques when executed by one or more processors. Memory 1020 can be one memory device or multiple memory devices. As discussed earlier, the memory will necessary include specialized features such as the protected and unprotected regions discussed with respect to FIGS. 1-2 and the special variable storage described in FIG. 2.

A computing environment may have additional features. For example, the computing environment 1000 includes storage 1040, one or more input devices 1050, one or more output devices 1060, and one or more communication connections 1090. An interconnection mechanism 1070, such as a bus, controller, or network interconnects the components of the computing environment 1000. Typically, operating system software or firmware (not shown) provides an operating environment for other software executing in the computing environment 1000, and coordinates activities of the components of the computing environment 1000.

The storage 1040 may be removable or non-removable, and includes magnetic disks, magnetic tapes or cassettes, CD-ROMs, CD-RWs, DVDs, or any other medium which can be used to store information and which can be accessed within the computing environment 1000. The storage 1040 may store instructions for the software 1080.

The input device(s) 1050 may be a touch input device such as a keyboard, mouse, pen, trackball, touch screen, or game controller, a voice input device, a scanning device, a digital camera, remote control, or another device that provides input to the computing environment 1000. The output device(s) 1060 may be a display, television, monitor, printer, speaker, or another device that provides output from the computing environment 1000.

The communication connection(s) 1090 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 1000, computer-readable media include memory 1020, storage 1040, communication media, and combinations of any of the above.

Of course, FIG. 10 illustrates computing environment 1000, display device 1060, and input device 1050 as separate devices for ease of identification only. Computing environment 1000, display device 1060, and input device 1050 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 1000 may be a set-top box, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

What is claimed is:

1. An image capture device, the image capture device comprising:
a memory, the memory comprising a first region accessible only to an authenticated user and a second region accessible to a non-authenticated user;
a camera configured to capture an image;
a switch having a first state and a second state; and
a controller configured to store the captured image in the memory, wherein the controller is configured to store the captured image in the first region when the switch is in the first state during image capture and store the captured image in the second region when the switch is in the second state during image capture.

2. The image capture device of claim 1, wherein the switch is configured to be toggled between the first state and the second state by a mechanical force.

3. The image capture device of claim 2, further comprising:
a depressible button configured to toggle the switch between the first state and the second state.

4. The image capture device of claim 1, wherein the controller is further configured to detect a state of the switch during image capture.

5. An image capture device, the image capture device comprising:
a memory, the memory comprising a first region accessible only to an authenticated user and a second region accessible to a non-authenticated user;
a camera configured to capture an image;
a variable stored in the memory, the variable having a first state and a second state; and
a controller configured to store a captured image in the memory, wherein the controller is configured to store the captured image in the first region when the switch is in the first state during image capture and store the captured image in the second region when the switch is in the second state during image capture.

6. The image capture device of claim 5, further comprising:
a display comprising a user interface, the user interface being configured to receive an input to toggle the variable between the first state and the second state.

7. The image capture device of claim 6, wherein the input comprises one of: a touch input, a swipe gesture, or a selection.

8. A method for secure image storage, the method comprising:
storing, in a memory of an image capture device, a first region accessible only to an authenticated user and a second region accessible to a non-authenticated user;
storing, in the memory of the image capture device, a variable having a first state and a second state;
capturing, by a camera of the image capture device, an image; and
storing, by the controller of the image capture device, the captured image in the memory, wherein the controller is configured to store the captured image in the first region when the variable is in the first state during image capture and store the captured image in the second region when the variable is in the second state during image capture.

9. The method of claim 8, further comprising:
receiving an input in a user interface on a display of the image capture device to toggle the variable between the first state and the second state.

10. The method of claim 9, wherein the input comprises one of: a touch input, a swipe gesture, or a selection.

11. The method of claim 8, further comprising:
detecting, by a controller of the image capture device, a state of the variable during image capture.

12. A method for secure image storage, the method comprising:
storing, in a memory of an image capture device, a first region accessible only to an authenticated user and a second region accessible to a non-authenticated user;
capturing, by a camera of the image capture device, an image; and
detecting, by a controller of the image capture device, a state of a switch of the image capture device during image capture, the switch having a first state and a second state; and
storing, by the controller of the image capture device, the captured image in the memory, wherein the controller is configured to store the captured image in the first region when the switch is in the first state during image capture and store the captured image in the second region when the switch is in the second state during image capture.

13. The method of claim 12, further comprising:
toggling the switch between the first state and the second state with a mechanical force.

14. The method of claim 13, further comprising:
toggling the switch between the first state and the second state with a depressible button.
